(19) United States
(12) Patent Application Publication
(10) Pub. No.: US 2024/0246068 A1
(43) Pub. Date: Jul. 25, 2024

(54) ZEOLITE FOR CARBON DIOXIDE CAPTURE AND METHOD FOR PREPARING THE SAME

(71) Applicant: GWANGJU INSTITUTE OF SCIENCE AND TECHNOLOGY, Gwangju (KR)

(72) Inventors: Sung Bong KANG, Gwangju (KR); Do Yeong KIM, Gwangju (KR)

(21) Appl. No.: 18/540,575

(22) Filed: Dec. 14, 2023

(30) Foreign Application Priority Data
Jan. 20, 2023 (KR) 10-2023-0008539
Nov. 21, 2023 (KR) 10-2023-0162257

(51) Int. Cl. B01J 37/30; B01D 53/86; B01J 29/40; B01J 35/61; B01J 37/08

(52) U.S. Cl. CPC B01J 37/30; B01D 53/8671; B01J 29/40; B01J 35/615; B01J 37/08; B01D 2255/2027; B01D 2255/504; B01D 2255/9207; B01D 2257/504; B01J 2229/186

(57) ABSTRACT

The present inventive concept relates to a surface-modified zeolite for direct air capture, and more particularly, to a zeolite for carbon dioxide capture whose surface is modified through sodium ion exchange. The zeolite for carbon dioxide capture is prepared by mixing a zeolite support and a supporting solution to form a mixed solution, heating the mixed solution to perform ion exchange, followed by evaporation, washing, drying and calcining. The resulting zeolite for carbon dioxide capture exhibits excellent CO₂ absorption/desorption performance and maintains consistent catalytic activity, allowing for reuse.

### CROSS-REFERENCE TO RELATED PATENT APPLICATION

This application claims the benefit of Korean Patent Application No. 10-2023-0008539, filed on Jan. 20, 2023 and No. 10-2023-0162257, filed on Nov. 21, 2023 in the Korean Intellectual Property Office, the disclosure of which is incorporated herein in its entirety by reference.

### BACKGROUND OF THE INVENTIVE CONCEPT

### 1. Field of the Inventive Concept

The present inventive concept relates to a zeolite for direct air capture at room temperature, and more specifically, to a zeolite that can capture carbon dioxide whose surface is modified through sodium ion exchange.

### 2. Description of the Related Art

Direct air capture, which has recently emerged as a key technology for carbon neutrality, is a technology that directly captures carbon dioxide from the atmosphere to produce concentrated carbon dioxide. The captured carbon dioxide can be permanently stored to remove carbon dioxide from the air or utilized as a raw material for various products. According to the IEA's 2050 Net Zero Emissions Report, the goal is to expand direct air capture to capture 60 Mt of CO₂ annually by 2030. However, compared to other technologies for carbon reduction, direct air capture is superior in terms of additionally and durability, but it has the disadvantage of being difficult to commercialize and incurring significant costs, especially in the early stages of research.

Conventional direct air capture technologies include solid direct carbon capture and liquid direct carbon capture. Among others, solid direct carbon capture is based on solid adsorbents that operate at atmospheric pressure and medium temperature. It can also be used to extract moisture from the air and is a modular form, which facilitates the facility's expansion. Moreover, compared to liquid direct carbon capture that utilizes absorption techniques, adsorption technology has the advantage of lower energy consumption and cost savings. Moreover, there is little loss of capture and no wastewater, leading to reduced environmental pollution.

However, capturing CO₂ from the air is inherently energy-intensive and more costly than extracting CO₂ from gas sources such as power plants. Furthermore, it faces challenges in large-scale implementation and commercialization at present due to being in the early stages of research. Therefore, there is a need for the development of adsorbents that maximize the potential for carbon removal to complement and address these limitations.

### SUMMARY OF THE INVENTIVE CONCEPT

The present inventive concept has been made in an effort to solve the above-described problems associated with prior art, and a first object of the present inventive concept is to provide a zeolite for carbon dioxide capture whose surface is modified through sodium ion exchange.

A second object of the present inventive concept is to provide a method for preparing a surface-modified zeolite for carbon dioxide capture to achieve the first object.

In order to achieve the first object as described above, the present inventive concept provides a zeolite for carbon dioxide capture whose surface is modified through sodium ion exchange.

In order to achieve the second object as described above, the present inventive concept provides a method for preparing a surface-modified zeolite for carbon dioxide capture. The zeolite may be obtained by mixing a zeolite and a supporting solution to form a mixed solution, followed by sodium ion exchange through heating, and the resulting zeolite may undergo additional processes such as washing, drying, and calcining.

According to the present inventive concept as described above, it is possible to reduce the atmospheric CO₂ concentration by using a zeolite whose surface is modified through sodium ion exchange to achieve a high CO₂ removal efficiency.

The interaction between the unique framework structure of zeolite and the ion-exchanged sodium ions results in high CO₂ adsorption/desorption performance. Exchange of cations within the zeolite with sodium ions enhances the basicity of the zeolite and provides adsorption sites for CO₂, allowing for efficient adsorption of acidic CO₂. Furthermore, by adjusting the Si/Al ratio, the sodium ions exchanged in two different forms within the zeolite can provide distinct CO₂ adsorption sites, enhancing the CO₂ adsorption capacity and maintaining the activity of the zeolite consistently during repeated use.

### BRIEF DESCRIPTION OF THE DRAWINGS

The above and other features and advantages of the present inventive concept will become more apparent by describing in detail exemplary embodiments thereof with reference to the attached drawings in which:

FIG. 1 is a flowchart illustrating a method for preparing a surface-modified zeolite for carbon dioxide capture according to a preferred embodiment of the present inventive concept;

FIG. 2 presents graphs showing the CO₂ adsorption performance measured with a thermal conductivity detector (TCD) during CO₂ breakthrough according to a preferred embodiment of the present inventive concept;

FIG. 3 presents graphs showing the adsorption amounts and the results of CO₂-temperature programmed desorption (CO₂-TPD) measured in the Preparation Examples depending on the type of zeolite according to a preferred embodiment of the present inventive concept;

FIG. 4 presents graphs showing the results of the CO₂-diffuse reflectance infrared Fourier transform spectroscopy (CO₂-DRIFTS) measured in the Preparation Examples depending on the type of zeolite according to a preferred embodiment of the present inventive concept;

FIG. 5 is a chemical structure diagram illustrating the Lewis acid-base interactions according to a preferred embodiment of the present inventive concept;

FIG. 6 is a graph illustrating the results of the CO₂-DRIFTS measured in the Preparation Examples depending on the type of zeolite according to a preferred embodiment of the present inventive concept;

FIG. 7 presents graphs showing the results of the CO₂-DRIFTS for CO₂ adsorption/desorption measured in the Preparation Examples depending on the type of zeolite according to a preferred embodiment of the present inventive concept;

FIG. 8 is a graph illustrating the results of the NH₃-TPD analysis measured with TCD in the Preparation Examples depending on the type of zeolite according to a preferred embodiment of the present inventive concept;

FIG. 9 presents graphs showing the adsorption amounts and the results of CO₂-TPD measured in the Preparation Examples depending on the Si/Al ratio according to a preferred embodiment of the present inventive concept;

FIG. 10 presents graphs showing the results of the sodium contents and CO₂ adsorption/desorption amounts measured in the Preparation Examples depending on the Si/Al ratio according to a preferred embodiment of the present inventive concept;

FIG. 11 is a graph showing the results of the CO₂ adsorption/desorption capacity during cycle repetition experiments according to a preferred embodiment of the present inventive concept; and

FIG. 12 is a graph illustrating the experimental results of adsorption/desorption capacity under simulated atmospheric conditions according to a preferred embodiment of the present inventive concept.

### DETAILED DESCRIPTION OF THE INVENTIVE CONCEPT

As the present inventive concept allows for various changes and numerous embodiments, particular embodiments will be illustrated in the drawings and described in detail in the written description. However, this is not intended to limit the present inventive concept to particular modes of practice, and it is to be appreciated that all changes, equivalents, and substitutes that do not depart from the spirit and technical scope of the present inventive concept are encompassed in the present inventive concept.

Unless defined otherwise, all terms used herein including technical or scientific terms have the same meaning as those generally understood by those skilled in the art to which the present inventive concept pertains. It will be further understood that terms defined in dictionaries that are commonly used should be interpreted as having meanings that are consistent with their meanings in the context of the relevant art and should not be interpreted as having ideal or excessively formal meanings unless clearly defined in the present application.

As used herein, the terms “direct air capture” and “carbon dioxide capture” refer to the capture of CO₂ from the atmosphere and can be interchangeably used throughout the specification.

Hereinafter, various s embodiments of the present inventive concept will be described in more detail with reference to the accompanying drawings.

### EXAMPLES

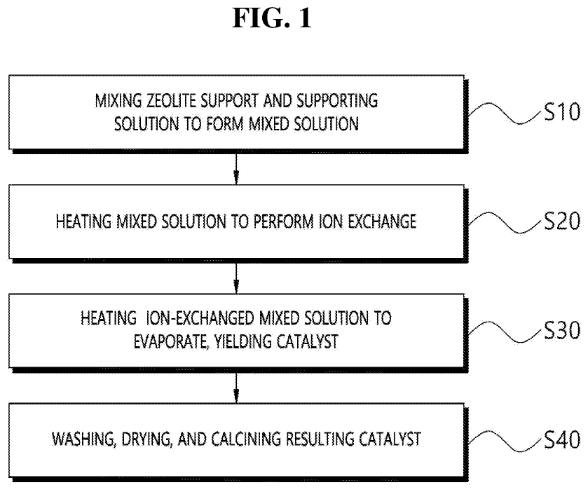

FIG. 1 is a flowchart illustrating a method for preparing a surface-modified zeolite for carbon dioxide capture according to a preferred embodiment of the present inventive concept.

Referring to FIG. 1, the zeolite for carbon dioxide capture whose surface is modified through sodium ion exchange may be prepared through a series of steps, including a first step (S10) of mixing a zeolite support and a supporting solution to form a mixed solution, a second step (S20) of heating the mixed solution to perform ion exchange, a third step (S30) of heating the ion-exchanged mixed solution to evaporate, yielding a catalyst, and a fourth step (S40) of washing, drying, and calcining the resulting catalyst.

In the first step (S10), a mixed solution is formed by mixing a zeolite support and a supporting solution. The zeolite may be at least one selected from the group consisting of ZSM-5, mordenite, Y and beta zeolites, and preferably ZSM-5. The use of a surface-modified zeolite prepared using ZSM-5 enhances the formation of Lewis base sites through sodium ion exchange, resulting in a superior CO₂ capture efficiency.

The supporting solution contains sodium cations and may comprise at least one selected from the group consisting of NaCl, NaNO₃ and NaOH, with the use of NaCl being more desirable.

In the second step (S20), the mixed solution is heated to perform ion exchange. The ion exchange refers to the substitution of protons within the zeolite with sodium ions. Through the ion exchange, the zeolite contains 1.0 wt % to 2.5 wt % of sodium ions, preferably 1.5 wt % to 2.5 wt % of sodium ions, and more preferably 1.8 wt % to 2.4 wt % of sodium ions. If the amount of sodium ions within the zeolite is less than 1.5 wt %, the interaction between the framework structure of the zeolite and the sodium ions may be insufficient, leading to a decrease in CO₂ adsorption/desorption performance, whereas if the amount of sodium ions within the zeolite exceeds 2.4 wt %, an excessive formation of Lewis base sites may occur, affecting the CO₂ adsorption/desorption performance.

In the third step (S30), the ion-exchanged mixed solution from the second step (S20) is heated to evaporate the liquid, yielding a surface-modified zeolite.

In the fourth step (S40), the zeolite obtained in the third step (S30) is washed, followed by drying and calcining, yielding a zeolite whose surface is modified through sodium ion exchange.

The zeolite prepared through the above steps has a specific surface area of 350 m²/g to 420 m²/g, more preferably a specific surface area of 395 m²/g to 418 m²/g. If the specific surface area is less than 350 m²/g, the CO₂ adsorption capacity may be compromised, and thus the desired effect of the present inventive concept cannot be achieved. Additionally, if the specific surface area exceeds 420 m²/g, the absorbency may be excessively high, making it difficult to selectively adsorb only CO₂.

The zeolite whose surface is modified through sodium ion exchange during the above steps may be any one of ZSM-5, Y zeolite, beta zeolite, and mordenite, which may be represented by Na-ZSM-5, Na-Y, Na-beta, and Na-mordenite.

In the above steps, the ZSM-5 has an NH₄-form and a Si/Al ratio of 11.5 to 16. If the Si/Al ratio is less than 11.5, it may affect the framework structure of ZSM-5, leading to insufficient structural space within the ZSM-5, whereas if the Si/Al ratio exceeds 16, the sodium ion exchange may not proceed smoothly, leading to a decrease in CO₂ adsorption/desorption performance.

The sodium ion-exchanged zeolite prepared through the above steps can adsorb CO₂ onto the surface at room temperature. The adsorption may involve sodium ions acting as Lewis acids and oxygen atoms of CO₂ acting as Lewis bases to form a complex compound.

### Preparation Example 1

3 g of ZSM-5 with a Si/Al ratio of 16 used as a support and 25 ml of 0.8 M NaCl solution used as a supporting solution were mixed, and the resulting mixture was stirred at 80° C. at 300 RPM for 1 hour three times to form an ion-exchanged mixed solution. The resulting mixed solution was evaporated at 80° C. in a rotary evaporator to obtain a sodium ion exchanged zeolite Na-ZSM-5. The obtained zeolite was washed eight times for 5 minutes each at 3500 RPM, dried at a temperature of 80° C. for one day, and then calcined at 550° C. for 4 hours, preparing a surface-modified zeolite.

### Preparation Example 2

Except for replacing ZSM-5 with mordenite zeolite, a surface-modified zeolite was prepared under the same conditions as Preparation Example 1 using the same process.

### Preparation Example 3

Except for replacing ZSM-5 with beta zeolite, a surface-modified zeolite was prepared under the same conditions as Preparation Example 1 using the same process.

### Preparation Example 4

Except for replacing ZSM-5 with Y zeolite, a surface-modified zeolite was prepared under the same conditions as Preparation Example 1 using the same process.

### Preparation Example 5

Except for using ZSM-5 as a support with a Si/Al ratio of 11.5, a surface-modified zeolite was prepared under the same conditions as Preparation Example 1 using the same process.

### Preparation Example 6

Except for using ZSM-5 as a support with a Si/Al ratio of 25, a surface-modified zeolite was prepared under the same conditions as Preparation Example 1 using the same process.

### Preparation Example 7

Except for using ZSM-5 as a support with a Si/Al ratio of 40, a surface-modified zeolite was prepared under the same conditions as Preparation Example 1 using the same process.

### Preparation Example 8

Except for using ZSM-5 as a support with a Si/Al ratio of 140, a surface-modified zeolite was prepared under the same conditions as Preparation Example 1 using the same process.

### Comparative Example 1

ZSM-5 without sodium ion exchange was used.

### Comparative Example 2

Mordenite zeolite without sodium ion exchange was used.

### Comparative Example 3

Beta zeolite without sodium ion exchange was used.

### Comparative Example 4

Y zeolite without sodium ion exchange was used.

### Measurement Example 1

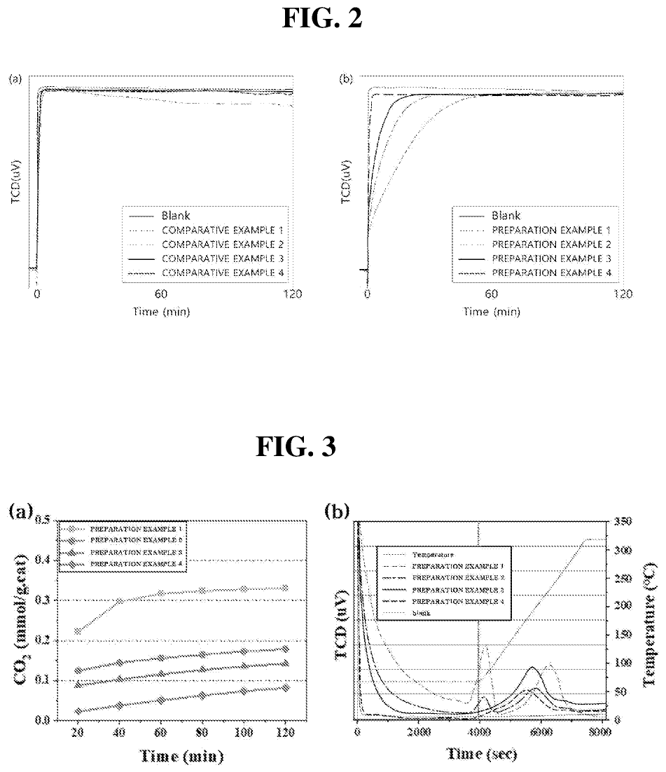

FIG. 2 presents graphs showing the CO₂ adsorption performance measured in the Preparation Examples and the Comparative Examples according to a preferred embodiment of the present inventive concept. The physical and chemical adsorption characteristics of zeolite as an adsorbent can be determined from the breakthrough curves in FIG. 2, and the adsorption amount were measured by allowing the adsorbent to adsorb gas until reaching equilibrium and calculating the amount of gas desorbed from the surface of the adsorbent while steadily increasing the temperature. At this time, the amount of desorbed gas was measured with a thermal conductivity detector (TCD).

Referring to FIG. 2, after pretreatment of the adsorbent at 350° C. for 5 hours with a He flow, CO₂ at a concentration of 400 ppm in the atmosphere was allowed to be adsorbed onto the surface of the adsorbent at 25° C. for 2 hours with a He flow of 100 sccm. Subsequently, purging with He was conducted at 25° C. for 1 hour to allow the physically adsorbed CO₂ to be desorbed. Then, the temperature was increased from 25° C. to 300° C. at a rate of 5° C./min, and after reaching 300° C., it was maintained for 30 minutes to allow the chemically adsorbed CO₂ to be desorbed.

In FIG. 2, (a) relates to the Blank and Comparative Examples 1 to 4. There was no significant difference in resistance between the use of zeolite and the non-use of zeolite (Blank), except for Comparison Example 2 where there was a slight difference. On the other hand, (b) relates to Preparation Examples 1 to 4, where the surface-modified zeolites were used. A lower TCD value was observed compared to the Blank without zeolite, leading to a change in the composition of the mobile phase, resulting in a decrease in thermal conductivity and consequently influencing the resistance value. Therefore, it can be inferred that Preparation Examples 1 to 4 showed an improvement in CO₂ capture ability, with Preparation Example 1 exhibiting the best performance.

### Measurement Example 2

FIG. 3 presents graphs showing the adsorption amounts and the results of CO₂-temperature programmed desorption (CO₂-TPD) measured in Preparation Examples 1 to 4 according to a preferred embodiment of the present inventive concept;

Referring to FIG. 3, depending on the type of zeolite used for each Preparation Example, (a) represents the adsorption amounts of CO₂ over time, and (b) relates to the results of CO2-TPD, which show the physical chemical adsorption amounts over time and temperature. The corresponding results are presented in Table 1.

TABLE 1

| | CO₂ capacity (mmol/g_{cat}.) | | CO₂/Na |
|---|---|---|---|
| | Adsorption | Desorption | (mol %) |
| Preparation | 0.33 | 0.34 | 41.3 |
| Example 1 | | | |
| Preparation | 0.18 | 0.16 | 27.3 |
| Example 2 | | | |
| Preparation | 0.14 | 0.18 | 17.9 |
| Example 3 | | | |
| Preparation | 0.082 | 0.046 | 14.1 |
| Example 4 | | | |

It can be seen from FIG. 3(a) and Table 1 that Preparation Example 1 exhibits a higher adsorption amount compared to Preparation Examples 2 to 4, with an average adsorption amount of 0.33 mmol/g_{cat}. The CO₂/Na was also measured at 41.3 mol %, which was higher than in other Preparation Examples. The reason for the higher adsorption amount of Preparation Example 1 compared to Preparation Example 2 to 4 is expected to be due to the presence of two desorption peaks generated by different types of ion-exchanged sodium ions as shown in of FIG. 3(b). In FIG. 3(b), the right side of the dotted line represents the chemical adsorption sites, and Preparation Example 1 shows peaks observed at 65° C. and 260° C. Moreover, the desorption peak appears at the highest temperature in Preparation Example 1, from which it can be inferred that the adsorption strength of CO₂ is high. The results of the measured physical adsorption amount on the left side show that Preparation Example 1 has the highest value. Therefore, it can be inferred that Na-ZSM-5 used in Preparation Example 1 is more suitable for CO₂ adsorption compared to using other types of zeolites, indicating that its framework structure and pore size are most suitable.

### Measurement Example 3

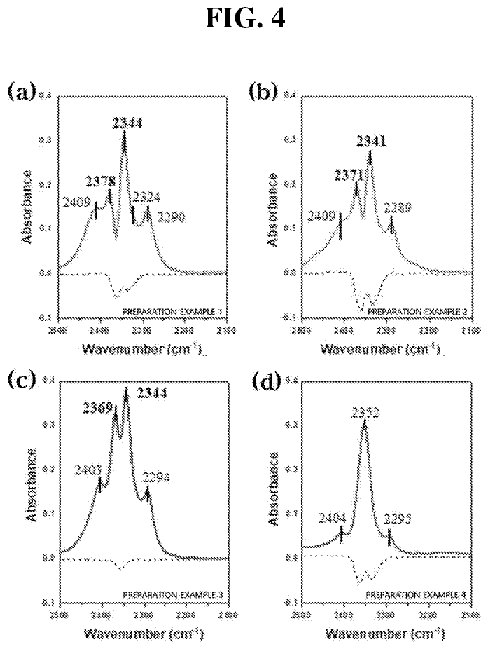

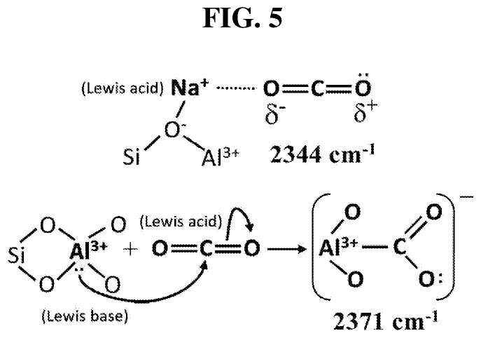

FIG. 4 presents graphs showing the results of the CO₂-diffuse reflectance infrared Fourier transform spectroscopy (CO₂-DRIFTS) measured in Preparation Examples 1 to 4 according to a preferred embodiment of the present inventive concept, and FIG. 5 is a chemical structure diagram illustrating the Lewis acid-base interactions according to a preferred embodiment of the present inventive concept. (a) to (d) of FIG. 4 correspond to Preparation Examples 1 to 4, respectively.

Referring to FIGS. 4 and 5, the peak at 2349 cm⁻¹ indicates gaseous CO₂, the peaks at 2409 cm⁻¹ to 2404 cm⁻¹ indicate the interaction between CO₂ and the zeolite in the Preparation Examples, and the peats at 2295 cm⁻¹ to 2286 cm⁻¹ indicate the interaction between CO₂ and sodium ions bound to the zeolite. Moreover, the peak at 2371 cm⁻¹ in the absorption peaks indicates the Lewis base behavior of Al in the zeolite, showing the interaction with CO₂. Since the peaks were observed in the corresponding spectra in Preparation Examples 1 to 3 of FIG. 4, it can be seen that the use of the sodium ion exchanged zeolite exhibits the superior adsorption of CO₂. In Preparation Examples 1 to 3, CO₂ was predominantly captured in Na⁺ and Al₃⁺. In Preparation Examples 1 to 3, the attachment of CO₂ to Na⁺ with Lewis acidic sites was observed with a peak at about 2344 cm⁻¹, and the attachment of CO₂ to Al₃⁺ with Lewis acidic sites was observed with a peak at about 2371 cm⁻¹. In Preparation Example 1, the peak was shifted to the left at 2371 cm⁻¹ due to the interaction with sodium ions, resulting in a peak at 2378 cm⁻¹ observed in FIG. 4. Although no clear peak was observed at 2371 cm⁻¹ in Preparation Example 4 compared to Preparation Examples 1 to 3, the presence of peaks in a similar range indicates that it is still suitable for CO₂ adsorption.

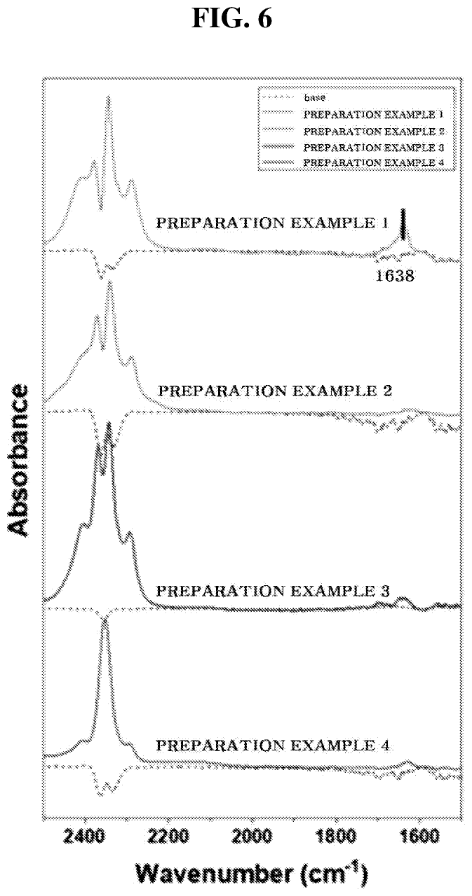

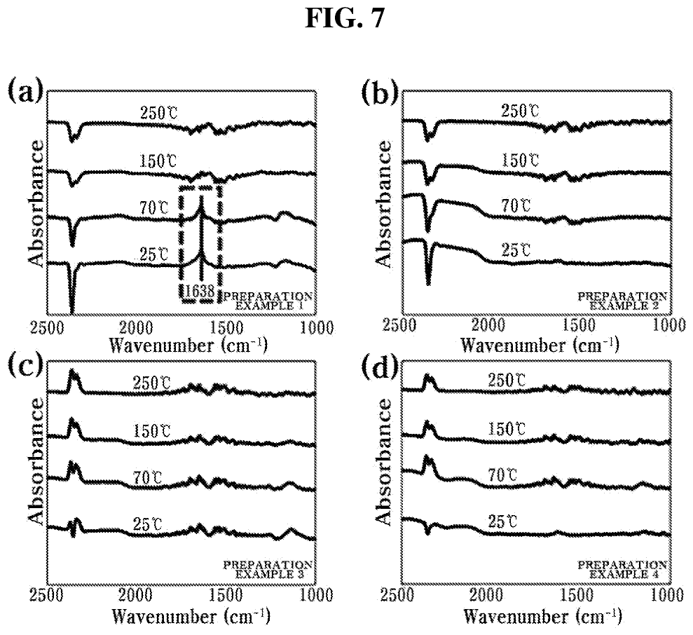

FIGS. 6 and 7 present graphs illustrating the results of DRIFTS analysis depending on CO₂ adsorption/desorption of Preparation Examples 1 to 4.

Referring to FIG. 6, when comparing Preparation Examples 1 to 4, a peak at 1638 cm⁻¹ was observed in Preparation Example 1, indicating that CO₂ was adsorbed in the form of bidentate carbonate. Moreover, referring to FIG. 7, a peak at 1638 cm⁻¹ was also observed in Preparation Example 1 of a, similar to FIG. 6. This peak was observed at a temperature below 70° C., and in (b) to (d), no distinct peak was observed in that region. Therefore, the adsorption of CO₂ in the form of bidentate carbonate observed in Preparation Example 1 as shown in FIG. 7(a) indicates that Preparation Example 1 exhibits excellent CO₂ adsorption/desorption performance.

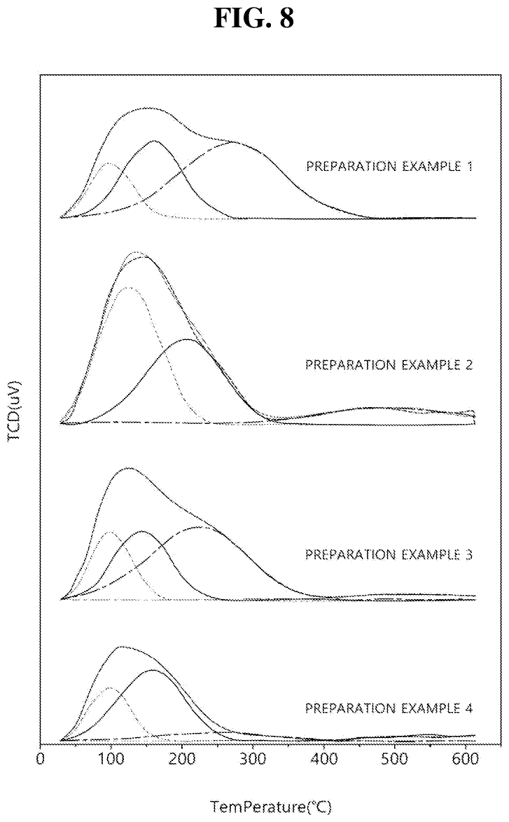

FIG. 8 is a graph illustrating the results of the NH₃-TPD analysis measured with TCD in Preparation Examples 1 to 4, and the measurement results are presented in Table 2 below.

TABLE 2

| | NH₃-TPD (mmol/g) | | | | Py-IR | | |
|---|---|---|---|---|---|---|---|
| | Weak | Moderate | Strong | Total | Weak | Moderate | Strong |
| Preparation | 0.77 | 0.95 | — | 1.72 | L | L | B |
| Example 1 | | | | | | | |
| Preparation | 1.71 | — | 0.32 | 2.03 | L | L | B |
| Example 2 | | | | | | | |
| Preparation | 0.72 | 0.83 | 0.09 | 1.68 | L | L | L + B |
| Example 3 | | | | | | | |
| Preparation | 0.77 | 0.11 | 0.07 | 0.95 | L | L + B | B |
| Example 4 | | | | | | | |

* Weak: below 200° C.; Moderate: 200° C. to 400° C.; Strong: above 400° C.
L: Lewis acid, B: Bronsted-Lowry acid

Referring to FIG. 8 and Table 2, it can be seen from the results of the NH₃-TPD analysis that each Preparation Example has three or four acid sites, respectively. The low-temperature peaks indicate the desorption of ammonia from weak acid sites, while the high-temperature peaks can be attributed to the desorption of ammonia from strong acid sites. In Preparation Example 1, the peaks were formed at higher temperatures compared to Preparation Examples 2 to 4, and the area ratio was increased, indicating the presence of strong acid sites. The results of Py-IR analysis, conducted to determine the types of acid sites, show that Preparation Example 1 had Lewis acid sites and exhibited higher values compared to Preparation Examples 2 to 4.

Therefore, it can be inferred that the Lewis base sites created through sodium ion exchange affect the CO₂ adsorption performance.

### Measurement Example 4

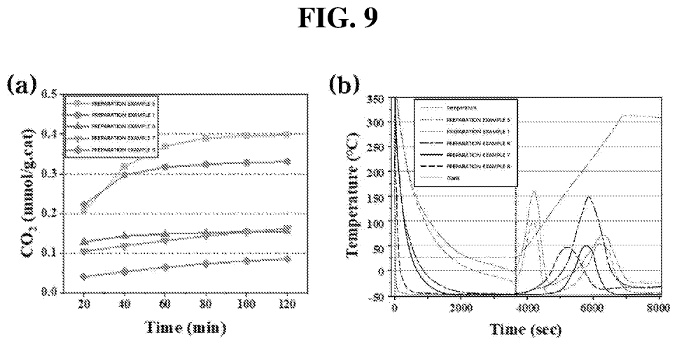

FIG. 9 presents graphs showing the CO₂ adsorption amounts of Preparation Example 1 and Preparation Examples 5 to 8.

Referring to FIG. 9, (a) is a graph illustrating the CO₂ adsorption amounts over time of Na-ZSM-5 with different Si/Al ratios, and (b) is a graph distinguishing between physical and chemical adsorption sites over time and temperature.

It was observed from (a) that as the Si/Al ratio decreases, the CO₂ adsorption amount increases. This can be attributed to the fact that as the Si/Al ratio in (b) increases, a single peak for CO₂ desorption at high temperatures is observed at the chemical adsorption site on the right side of the dotted line, indicating that the chemical adsorption is less efficient than in zeolite with low Si/Al ratios. The reason for observing a single desorption peak is that as the Si/Al ratio increases, the relatively low-energy sodium ions are pushed out. Preparation Examples 1 and 5 with low Si/Al ratios increase the adsorption strength of sodium ions and CO₂, causing the CO₂ desorption peak to shift to higher temperatures.

Preparation Example 1 and 5 with low Si/Al ratios also exhibited excellent physical adsorption performance. Therefore, it can be inferred that Na-ZSM-5 with low Si/Al ratios exhibits high CO₂ adsorption capacity and strong interaction between zeolite and CO₂.

TABLE 3

| | | Na-form | | | | |
|---|---|---|---|---|---|---|
| | | | | CO₂ capacity (mmol/g_{cat.}) | | CO₂/Na |
| | Si/Al | BET (m²/g) | Na (wt %) | Adsorption | Desorption | (mol %) |
| Preparation | 11.5 | 418 | 2.4 | 0.4 | 0.46 | 39.2 |
| Example 5 | | | | | | |
| Preparation | 16 | 395 | 1.8 | 0.33 | 0.34 | 41.3 |
| Example 1 | | | | | | |
| Preparation | 25 | 429 | 1.0 | 0.16 | 0.21 | 32.6 |
| Example 6 | | | | | | |
| Preparation | 40 | 474 | 0.7 | 0.16 | 0.11 | 51.6 |
| Example 7 | | | | | | |
| Preparation | 140 | 497 | 0.3 | 0.085 | 0.1 | 70.8 |
| Example 8 | | | | | | |

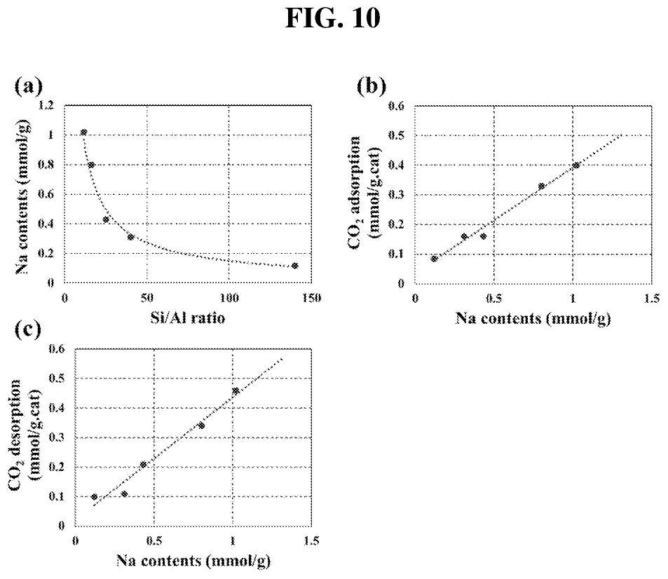

FIG. 10 presents graphs showing the correlation between the Si/Al ratio and the CO₂ adsorption/desorption amount depending on the sodium ion ratio for Preparation Examples 1 and 5 to 8, and the corresponding results are presented in Table 3 above.

Referring to FIG. 10 and Table 3, (a) is a graph illustrating the sodium ion content depending on the Si/Al ratio. As the Si/Al ratio decreases, the sodium ion content increases. Based on this, (b) and (c) show a linear relationship in the sodium ion content and the CO₂ adsorption and desorption amounts. Therefore, it can be inferred that as the Si/Al ratio decreases, the sodium ion content increases, thereby improving the performance of CO₂ adsorption and desorption.

### Measurement Example 5

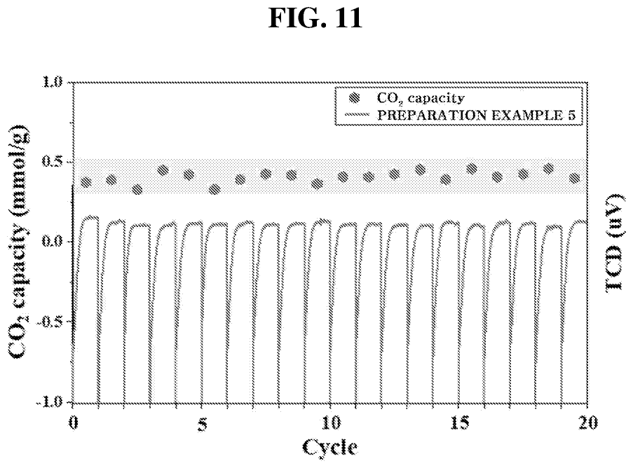

FIG. 11 is a graph showing the results of the CO₂ adsorption/desorption capacity during cycle repetition experiments in Preparation Example 5.

Referring to FIG. 11, it can be seen that Preparation Example 5 maintains excellent adsorption/desorption performance up to 20 cycles, indicating that the performance does not degrade even with repeated use.

### Measurement Example 6

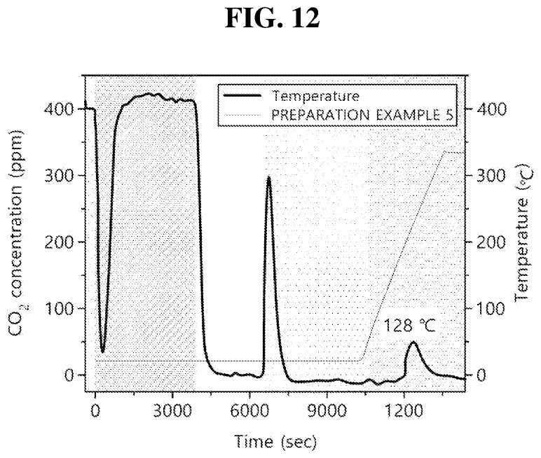

FIG. 12 is a graph illustrating the CO₂ adsorption/desorption performance of Preparation Example 5 in the atmosphere. Referring to FIG. 12, CO₂ adsorption was measured by pretreatment of the adsorbent at 350° C. for 5 hours with an N₂ flow, followed by adsorption of 400 ppm of CO₂ at 25° C. for 1 hour with an N₂ flow of 200 sccm in equilibrium with 21% O₂ and N₂. Subsequently, purging with He was conducted at 25° C. for 1 hour, and the temperature was then increased from 25° C. to 300° C. at a rate of 5° C./min, followed by desorption of CO₂ at 300° C. for 30 minutes, with the desorption peak observed at 128° C. The measured results of CO₂ adsorption and desorption are presented in Table 4 below.

TABLE 4

CO₂ capacity (mmol/g_{cat}.)

| | Conditions | Adsorption | Desorption |
|---|---|---|---|
| Preparation | w/o O₂ in He | 0.4 | 0.46 |
| Example 5 | w/O₂ in N₂ | 0.25 | 0.23 |

Table 4 above compares the CO₂ adsorption/desorption performance when O₂ is included in N₂ and when O₂ is not included in He. When the experiment was conducted with O₂ under conditions similar to atmospheric concentrations, the performance is lower than when O₂ was absent. However, under the condition where O₂ is not included in He, the total flow rate is 100 sccm, which is twice as different from this experiment, and thus it is expected that the performance degradation would not be significant even when conducting CO₂ absorption/desorption under atmospheric conditions.

Therefore, it is preferable to use Na-ZSM-5 catalyst with a Si/Al ratio of 11.5 for CO₂ capture.

According to the present inventive concept as described above, it is possible to reduce the atmospheric CO₂ concentration by using a zeolite whose surface is modified through sodium ion exchange to achieve a high CO₂ removal efficiency. Moreover, the interaction between the unique framework structure of zeolite and the ion-exchanged sodium ions results in high CO₂ adsorption/desorption performance. Exchange of cations within the zeolite with sodium ions enhances the basicity of the zeolite and provides adsorption sites for CO₂, allowing for efficient adsorption of acidic CO₂. Furthermore, by adjusting the Si/Al ratio, the sodium ions exchanged in two different forms within the zeolite can provide distinct CO₂ adsorption sites, enhancing the CO₂ adsorption capacity and maintaining the activity of the zeolite consistently during repeated use.

While the inventive concept has been shown and described with reference to certain preferred embodiments thereof, it will be understood by those skilled in the art that various changes in form and details may be made therein without departing from the spirit and scope of the inventive concept as defined by the appended claims. Therefore, the scope of the inventive concept is defined not by the detailed description of the inventive concept but by the appended claims, and all differences within the scope will be construed as being included in the present inventive concept.

What is claimed is:

1. A zeolite for carbon dioxide capture that selectively captures carbon dioxide at room temperature,
wherein the zeolite is surface-modified through sodium ion exchange and comprise at least one selected from the group consisting of ZSM-5, beta zeolite, and mordenite.

2. The zeolite for carbon dioxide capture of claim 1, wherein the sodium ion exchange is a process where protons within the zeolite are substituted with sodium ions.

3. The zeolite for carbon dioxide capture of claim 1, wherein the zeolite is Na-ZSM-5 with a Si/Al ratio of 11.5 to 16.

4. The zeolite for carbon dioxide capture of claim 3, wherein the Na-ZSM-5 has a specific surface area of 350 m²/g to 420 m²/g.

5. The zeolite for carbon dioxide capture of claim 3, wherein the Na-ZSM-5 contains 1.0 wt % to 2.5 wt % of sodium ions.

6. A method for preparing a zeolite for carbon dioxide capture, comprising the steps of:
mixing a zeolite support ZSM-5 and a supporting solution to form a mixed solution;
heating the mixed solution to perform ion exchange; and
heating the ion-exchanged mixed solution to evaporate, yielding a catalyst,
wherein the ion exchange is a process where protons within the ZSM-5 are substituted with sodium ions, forming Na-ZSM-5.

7. The method for preparing a zeolite for carbon dioxide capture of claim 6, wherein the Na-ZSM-5 has an NH₄-form and a Si/Al ratio of 11.5 to 16.

8. The method for preparing a zeolite for carbon dioxide capture of claim 6, wherein the supporting solution contains sodium cations and comprises at least one selected from the group consisting of NaCl, NaNO₃ and NaOH.

9. The method for preparing a zeolite for carbon dioxide capture of claim 6, wherein the Na-ZSM-5 contains 1.0 wt % to 2.5 wt % of sodium ions.

10. A method of adsorbing carbon dioxide using a zeolite for carbon dioxide capture, comprising the steps of:
preparing a sodium ion-exchanged zeolite; and
feeding CO₂ to the zeolite at room temperature to allow CO₂ to be adsorbed onto the zeolite;
wherein the adsorption involves involve ions acting as Lewis acids and oxygen atoms of CO₂ acting as Lewis bases to form a complex compound, and
wherein the sodium ions are contained in an amount of 1.0 wt % to 2.5 wt %.

11. The method of adsorbing carbon dioxide using a zeolite for carbon dioxide capture of claim 10, wherein the zeolite is Na-ZSM-5 with a Si/Al ratio of 11.5 to 16.

12. The method of adsorbing carbon dioxide using a zeolite for carbon dioxide capture of claim 11, wherein the Na-ZSM-5 has a specific surface area of 350 m²/g to 420 m²/g.
